(19) United States
(12) Patent Application Publication
(10) Pub. No.: US 2016/0103969 A1
(43) Pub. Date: Apr. 14, 2016

(54) CHRONIC DISEASE MANAGEMENT AND WORKFLOW ENGINE

(71) Applicant: COMPUGROUP MEDICAL AG, Koblenz (DE)

(72) Inventors: Werner Rodorff, Scottsdale, AZ (US); Jerry Maynard Kizziar, SR., Laveen, AZ (US)

(21) Appl. No.: 14/513,307

(22) Filed: Oct. 14, 2014

(51) Int. Cl. G06F 19/00

(52) U.S. Cl. CPC G06F 19/3418

(57) ABSTRACT

The present invention relates to a method for monitoring a chronic disease using a chronic disease management device, the chronic disease management device comprising a rule engine unit and a receiving unit, the method comprising: providing a database for storing a plurality of clinical items related to the chronic disease; receiving, by the receiving unit, at a first point in time first data from a first user of the chronic disease management device, the first data being indicative of first values of at least part of the plurality of clinical items; selecting by the rule engine a set of clinical items of the plurality of clinical items using at least the first values, each or some of the set of clinical items being associated with a final target value; determining, by the rule engine unit, a set of target values including intermediate target values and the final target value for each or some of the set of clinical items, the set of target values being sequenced chronologically, wherein the final target value is last in the sequence; generating, by the rule engine unit, a documentation set comprising the set of clinical items and respective set of target values associated with each clinical item of the set of clinical items; storing, by the rule engine unit, the documentation set in the database.

### TECHNICAL FEILD

This invention relates generally to medical processing systems. More specifically, this invention relates to an improved apparatus and method for monitoring a chronic disease.

### BACKGROUND

The chronic diseases have the greatest negative impact on health care and associated costs in most countries. Multiple ways have been explored in the last years to help improving quality of care for patients with these diseases. One of the important care programs is to derive out the clinical situation of a patient suffering from chronic diseases based on actions, goals, referrals, tasks, alerts, reminders or any other clinical procedure. However, a need remains for improving such clinical procedures for the patient and other state holders in the managed care process.

### SUMMARY

Various embodiments provide a method and apparatus for monitoring a chronic disease as described by the subject matter of the independent claims. Advantageous embodiments are described in the dependent claims.

In one aspect, the invention relates to a method for monitoring a chronic disease using a chronic disease management device, the chronic disease management device comprising a rule engine unit and a receiving unit. The method comprises:
a. providing a database for storing a plurality of clinical items related to the chronic disease,
b. receiving, by the receiving unit, at a first point in time first data from a first user of the chronic disease management device, the first data being indicative of first values of at least part of the plurality of clinical items,
c. selecting by the rule engine a set of clinical items of the plurality of clinical items using at least the first values, each or some of the set of clinical items being associated with a final target value,
d. determining, by the rule engine unit, a set of target values including intermediate target values and the final target value for each or some of the set of clinical items, the set of target values being sequenced chronologically, wherein the final target value is last in the sequence,
e. generating, by the rule engine unit, a documentation set comprising the set of clinical items and respective set of target values associated with each clinical item of the set of clinical items,
f. storing, by the rule engine unit, the documentation set in the database;
g. for each or some of the set of clinical items:
   i. defining a given target value as the first target value of the set of target values,
   ii. providing, by the rule engine unit, a predefined second point in time for receiving a second value of the clinical item,
   iii. receiving, by the receiving unit, at the second point in time the second value for the clinical item from the first user,
   iv. comparing, by the rule engine unit, the second value with at least the given target value,
   v. assigning a score to the first user indicative of the clinical status of the first user at the second point in time using the results of the comparison,
   vi. repeating steps ii)-v) with the given target value being a non-used target value of the set of target values until usage of at least part of the set of target values,
   h. based on the scores, repeating steps c)-g) or repeating steps d)-g) until a predefined disease treatment convergence criterion is met.

In another aspect, the invention relates to a tangible computer-readable recording medium comprising computer executable instructions to perform the method steps of the method of any one of the preceding embodiments.

In another aspect the invention relates to a chronic disease management device for monitoring a chronic disease, the chronic disease management device comprising a database for storing a plurality of clinical items related to the chronic disease. The chronic disease management device further comprises:
a receiving unit for receiving, at a first point in time first data from a first user of the chronic disease management device, the first data being indicative of first values of at least part of the plurality of clinical items;
a rule engine unit for:
   1) selecting a set of clinical items of the plurality of clinical items using at least the first values, each or some of the set of clinical items being associated with a final target value;
   2) determining a set of target values including intermediate target values and the final target value for each or some of the set of clinical items, the set of target values being sequenced chronologically, wherein the final target value is last in the sequence;
   3) generating a documentation set comprising the set of clinical items and respective set of target values associated with each clinical item of the set of clinical items;
   4) storing the documentation set in the database;
   5) for each or some of the set of clinical items:
      i. defining a given target value as the first target value of the set of target values;
      ii. providing a predefined second point in time for receiving a second value of the clinical item;
      iii. receiving, via the receiving unit, at the second point in time the second value for the clinical item from the first user;
      iv. comparing the second value with at least the given target value;
      v. assigning a score to the first user indicative of the clinical status of the first user at the second point in time using the results of the comparison;
      vi. repeating steps ii)-v) with the given target value being a non-used target value of the set of target values until usage of at least part of the set of target values;
   6) based on the scores, repeating steps 1)-5) or repeating steps 2)-5) until a predefined disease treatment convergence criterion is met.

### BRIEF DESCRIPTION OF THE DRAWINGS

In the following embodiments of the invention are explained in greater detail, by way of example only, making reference to the drawings in which:

FIG. 1 shows a block diagram of a chronic disease management device,

FIG. 2 is a flowchart of a method for monitoring a chronic disease,

FIG. 3 shows a vocabulary containing clinical items,

FIG. 4 is a flowchart of a method for selecting a set of clinical items,

FIG. 5 shows another example content of the vocabulary,

FIG. 6 shows a database diagram, and

FIG. 7 shows another example content of the vocabulary.

### DETAILED DESCRIPTION

In the following, like numbered elements in the figures either designate similar elements or designate elements that perform an equivalent function. Elements which have been discussed previously will not necessarily be discussed in later figures if the function is equivalent.

The features of the above mentioned method may have the advantage of providing an optimal management of chronic diseases by constantly tracking and establishing the patient's clinical status and adapting the goals according to intermediate progresses the patient (and provider in treating the patient) makes.

In contrast to a pure mathematical approach that individually checks the precision of every clinical item, the usage of scoring and scores may allow an effective establishment of the clinical status of a patient that may not be based on a black and white judgment. A balance may be found between the different clinical items taking, for example, into account their relations or dependencies so as to decide whether they collectively contribute to a desired clinical status for a given patient. For example, the disease treatment convergence criterion may be met although not all clinical items have reached their final target values for a given patient. However, for another patient even if all clinical items satisfy/reach their final target values the disease treatment convergence criterion may not be met, as the disease treatment convergence criterion may be defined with a safety margin (e.g. a clinical status that is 20% better than the clinical status defined by the final target values).

The usage of an iterative approach based on different clinical items and intermediate goals may allow an optimal usage of the chronic disease management device. That is, the number of interactions with the chronic disease management device may be controlled and e.g. reduced to a minimum. This may save resources in the chronic disease management device that would otherwise be required when the chronic disease management device is not systematically used e.g. with an non-iterative approach.

For example, the selection of the set of clinical items may be based on a comparison of the first values with first threshold values or with other clinical data. The first threshold values may be different from the final target values associated with the set of clinical items.

For example, step h) may be performed based on a combination of the scores in a single combined score.

For example, after step h) the method may further comprise monitoring the set of clinical items using for example a smaller set of target values and in a less frequent manner.

The term “clinical item” refers to clinical markers or clinical indicia to evaluate the clinical status of a patient. A clinical item may comprise, without limitation: Low-density lipoprotein (LDL), High-density lipoprotein (HDL), systolic blood pressure, body mass index (BMI), waist size, body height, body weight, gender, age, glucose, diastolic blood pressure, HbA1c, cigarette smoking, and the like. The clinical item may further comprise measures derived from combinations of the above, and other data obtained from the patient.

In parallel to defining clinical items and target values to be monitored, the first user e.g. a patient may also receive a plan of a medication, education on nutrition and/or sport activities that may have to follow e.g. between the first and second points or between second points in time.

According to one embodiment, step h) comprises calculating a combined score using the scores of the set of clinical items; providing a lower score limit and an upper score limit; in response to determining that the combined score is below the lower score limit repeating steps c)-g); in response to determining that the combined score is within the range defined by the lower and upper score limits repeating steps d)-g); wherein the disease treatment convergence criterion comprises the combined score being higher than the upper score limit.

The combined score may be calculated using the scores obtained for every clinical item in the set of clinical items and for every repetition of steps ii)-v) e.g. for every target value associated with the clinical item. The fact that the decision to re-define the target values or the set of clinical items is based on a single value which is the combined score may prevent the usage of a tedious decision method based on multi-dimensional comparison of multiple clinical items and their associated thresholds.

By considering/combining the scores of all clinical items that have been monitored, an accurate and reliable clinical status of a patient may be provided by the chronic disease management device as the clinical items may have dependencies that may be taken into account. Also, this embodiment may further reduce the number of interactions (usage) of the chronic disease management device compared to an individual monitoring approach of clinical items where the number of interactions may increase with the number of clinical items.

According to one embodiment, the at least part of the plurality of clinical items comprises the set of clinical items, wherein calculating the combined score comprises:

calculating for each or some of the set of clinical items a relative shift value of the first value of the clinical item to the final target value of the clinical item; sorting by the relative shift value the set of clinical items; assigning a weight to each or some of the set of clinical items in accordance with the sort; calculating the combined score as a weighed sum of the scores using the assigned weights.

For example, the set of clinical items comprises the weight of the patient as well as the blood pressure of the patient. The first values received at the first point in time may or may not comprise a value of the weight of the patient. In case the weight is not part of the first values, it may be selected because it depends on another clinical item such as cholesterol level of the patient for which the first value have been received. That is, the first value of the weight may or may not be known. In both cases, the target values for the weight may be defined as 90 Kg, 80 Kg and 70 Kg, with 70 Kg being the final target value of the weight (this example may be preferable for patient suffering from obesity).

If at the first visit (i.e. at the first point in time) the patient has a weight value which is close to 70 Kg a weight of 0.2 may be assigned to the weight. However, if the weight value is too far from the 70 Kg a maximal weight of 1 may be assigned. Assume that the weight was close to 70 Kg at the first point in time, thus weight 0.2 is assigned to clinical item ‘weight’. However, the blood pressure was too far from the final target value such that a weight of 0.9 is assigned to clinical item “blood pressure”. In this way the combined score which combines the scores of the weight as well as the blood pressure may put emphasis on the clinical item which was not good at the very beginning (first point in time).

In another example, the disease treatment convergence criterion may be defined using the scores of independent clinical items only. For example, if the set of clinical items comprises 3 items two of them depend on each other e.g. weight and cholesterol level, only the scores of two items out of the three may be used e.g. only the weight item (and not the cholesterol level) and the third item. The disease treatment convergence criterion may be met, for example, if the score of each of the two clinical items are higher than a predefined respective threshold value.

According to one embodiment, the repetition of steps c)-g) results in two or more iterations, wherein each clinical item of the plurality of the clinical items is associated with zero or more dependencies indicative of the dependency of the clinical item to respective zero or more clinical items of the plurality of clinical items; wherein selecting the set of clinical items of the plurality of clinical items comprises: for each clinical item of the at least part of the clinical items for the first iteration or for each clinical item of the set of clinical items for a subsequent iteration: determining zero or more dependent clinical items from the plurality of clinical items using the dependency values of the clinical item; assigning to each dependent clinical item of the zero or more dependent clinical items an initial selection threshold value, the initial selection threshold value being determined using the dependency value of the clinical item to the dependent clinical item; comparing the first value of the clinical item with each of the initial threshold values for the first iteration or comparing the second values of the clinical item with each of the initial threshold values for the subsequent iteration; selecting at least part of the zero or more dependent clinical items to be part of the set of clinical items based on the results of the comparison.

As used herein, the term iteration refers to the repetition of steps 1)-N) and also refers to the first or initial execution of steps 1)-N). In other terms, a single repetition of steps 1)-N) results in two iterations, the first iteration corresponds to the initial execution of steps 1)-N) while the second iteration corresponds to the first repetition of steps 1)-N).

The dependency values may be values associated with the dependencies. They may comprise an indication of other clinical items such an ID or a name etc.

This embodiment may provide an automatic and a reliable method for selecting the set of clinical items by taking into account the dependencies between the clinical items. This may be particularly advantageous in case of a high number of clinical items from which the set of clinical items may be selected as it may avoid an ad-hoc selection of the set of clinical items that is an error-prone approach.

According to one embodiment, the repetition of steps d)-g) results in two or more iterations, wherein after each ended iteration of the two or more iterations and for each clinical item of the set of clinical items the method further comprises modifying the set of target values of the ended iteration using the score of the clinical item.

According to one embodiment, modifying comprises one of: shifting the set of target values of the ended iteration using the score; adding one or more intermediate target values to the set of target values of the ended iteration, and deleting one or more intermediate target values of the set of target values of the ended iteration.

For example, in case the monitoring of a clinical item may result in a good score, this clinical item may be deleted from the set of clinical items which may then further reduce the number of interactions with the chronic disease management device as the number of clinical items to be monitored is reduced. In an alternative example, in case the monitoring of a clinical item may result in a good score, this clinical item may still be monitored but using a smaller set of target values (compared to the one used before the good score is obtained) e.g. having a single target value and less frequently monitored or checked.

In another example, a new clinical item may be added based on the score obtained for a given clinical item from which it depends. This may be required so as to provide a reliable diagnosis of the status of the patient.

According to one embodiment, the repetition of steps c)-g) results in two or more iterations, wherein for each subsequent iteration after the first iteration the selection of step c) is performed using the first values and the second values of each clinical item of the set of clinical items of the previous iteration. This may increase the accuracy of the selection method.

According to one embodiment, the repetition of steps ii)-v) resulting in two or more iterations, the repetition of steps ii)-v) being performed until at least one of the following conditions is fulfilled: the score becomes higher than a predefined minimum score value associated with the clinical item, the time elapsed between the first and the second point in time is higher than a predetermined maximum monitoring period of the clinical item, and the second value having been checked against each target value of the set of the target values.

For example, if the score assigned to a clinical item is already good enough at the second appointment with the patient e.g. at the second point in time, there is no need to check with all intermediate target values or only part of the intermediate target values may be monitored.

In another example, since the second point in time may automatically be determined by the chronic disease management device, a meaningful monitoring or follow up may not be achieved if the elapsed time between the first point in time and the second point in time is too long. This embodiment may control such situation by stopping the repetition as the monitoring may not be efficient or useful.

In another example, the predetermined maximum monitoring period of the clinical item may be determined using the lifetime of a power supply e.g. a battery of the chronic disease management device e.g. the predetermined maximum monitoring period of the clinical item may be less than 70% of the lifetime of the power supply. This may make sure that the chronic disease management device is still usable at least until the end of the monitoring process as defined above.

According to one embodiment, the assigned score is calculated using the relative shift value of the second value to the given target value.

According to one embodiment, the repetition of steps ii)-v) resulting in two or more iterations each associated with a respective score, wherein the score of the clinical item is the sum of the scores of each of the two or more iterations. This may provide a time dependent evaluation of the clinical status of the patient and may avoid the case where only one e.g. the last score is considered which may be a fake or accidental score that does not reflect the real clinical status of the patient.

According to one embodiment, the comparison of the second value with at least the given target value comprises comparing the second value with the given target value and the final target value. This may speed up the convergence process as it may avoid additional iterations in case the final target value is already reached in a previous iteration.

According to one embodiment, the second point in time is received by the rule engine unit from a second user of the chronic disease management device and stored in the chronic disease management device.

In another example, the second point in time may be automatically defined by the chronic disease management device using the first and/or second values as well as at least the final target value of the sequence of target values.

According to one embodiment, the repetition in step h) results in two or more iterations, wherein the set of target values of at least the first iteration are received from a second user of the chronic disease management device.

According to one embodiment, the second user is logged into the chronic disease management device using a first login of the first user and a second login of the second user. Using two logins may permit access of the second user to the right data related to the first user. For example, the second user may be a doctor while the first user is a patient, and using the first login may avoid that the doctor access/use the data of another patient. The first user may be a doctor and the second user may be a patient.

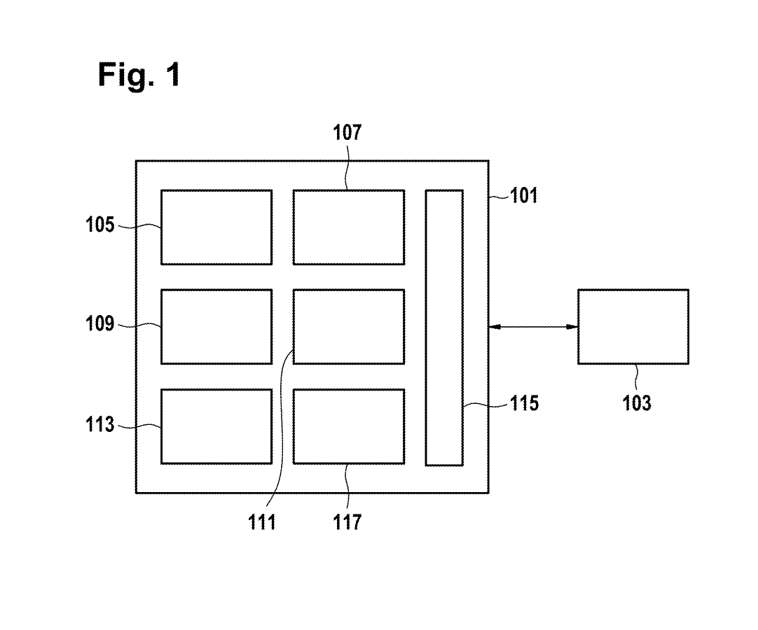

FIG. 1 is a block diagram of a chronic disease management device 101 connected to a computer system 103. The diagram schematically illustrates a communication link 105 between the chronic disease management device (CSMD) 101 and the computer system 103. The communication link may be a wireline such as a wire communication bus and/or wireless connection.

CSMD 101 includes controller unit 107, which may comprise a memory (e.g. RAM, ROM, EEPROM), and/or a processor. CSMD 101 further comprises a power supply 109 to provide power to CSMD 101. CSMD 101 further comprises a rule engine unit 111. The rule engine unit 111 comprises a clock 113 to provide timing to CSMD 101. Communication unit 115 communicates with remote computer system 103. Communication unit 115 also contains a transceiver to transmit and receive data over communication link 105. CSMD 101 may further comprise a storage system 117.

In another example, the CSMD 101 may be a handheld mobile device having a touch sensitive display screen that can be used for input-output interactions with a user of the CSMD 101.

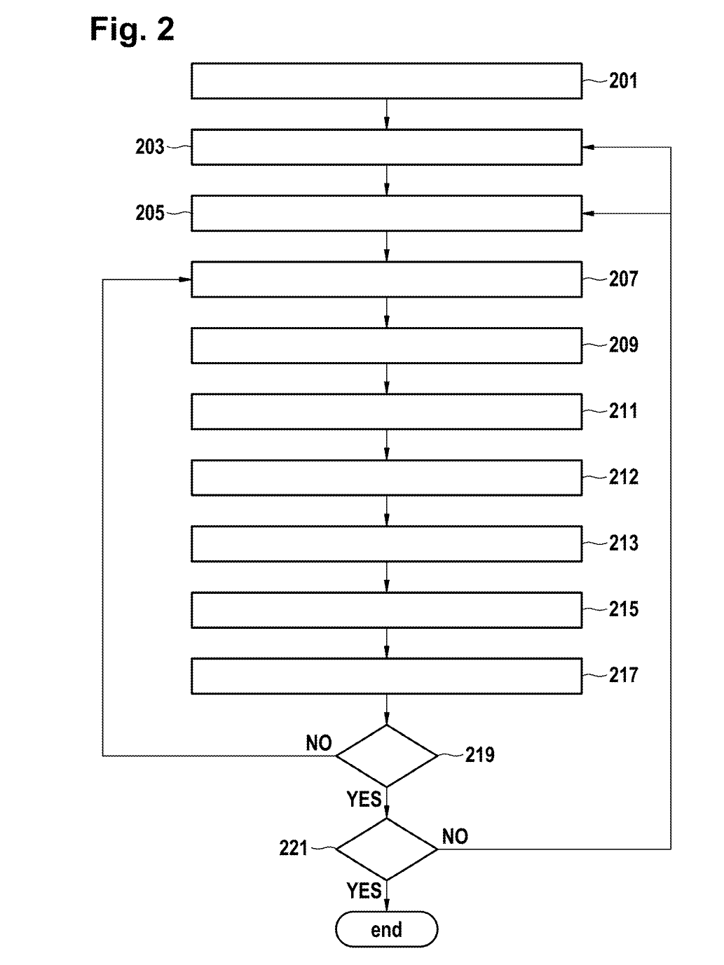

The operation of CSMD 101 will be described in more details with reference to FIG. 2.

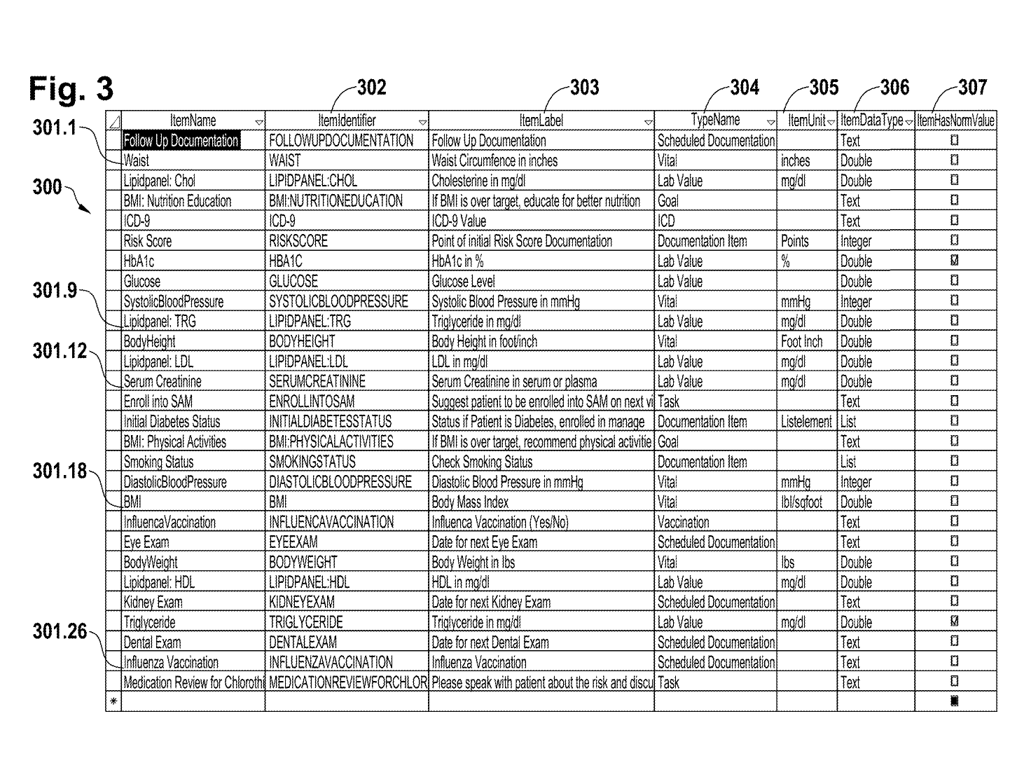

FIG. 2 is a flowchart of a method for monitoring a chronic disease using a chronic disease management device such as CSMD 101, where the storage system 117 comprises a database for storing a plurality of clinical items related to the chronic disease. The database may, for example, comprise the vocabulary 300 as shown with reference to FIG. 3.

In step 201, the communication unit 115 may receive, at a first point in time first data from a first user of CSMD 101. The first user may be, for example, the computer system 103 or a user of the computer system 103. The first data may be received at the computer system 103 form the user e.g. a patient or doctor. The first data indicate first values of at least part of the plurality of clinical items 301. For example, the at least part of the plurality of clinical items may comprise clinical items 301.1-301.9. The first values may be values of the clinical items 301.1-301.9 that have been measured for the patient before the first point in time.

The first values may be used to establish a starting point for the patient such that a risk analysis or other analysis is performed (e.g. by determining the likelihood for the patient to suffer from a specific disease in the future by comparing the first values against predefined threshold values) or in case the patient is already diagnosed with a specific chronic disease. Depending on the outcome of the analysis or the specific health and clinical status of the patient; goals, actions, tasks, etc. may be defined as described below.

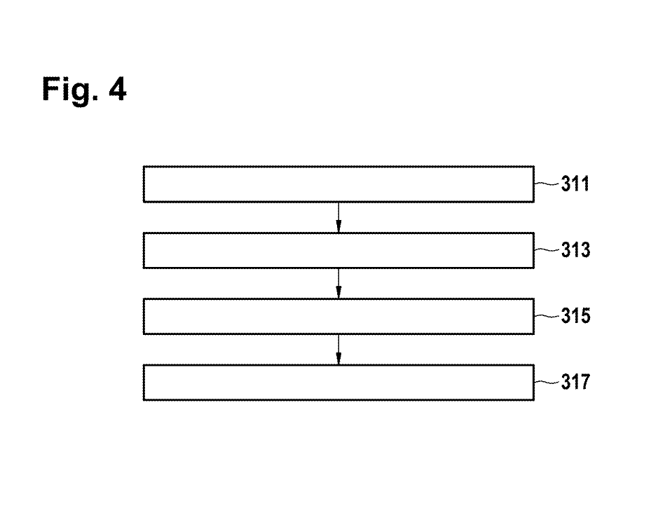

In step 203, the rule engine unit 111 may select a set of clinical items of the plurality of clinical items using at least the first values. The set of clinical items may comprise items of the at least part of the plurality of clinical items 301.1-301.9 and/or other clinical items of the rest of clinical items 301.10-301.26 of the plurality of clinical items. For example, a clinical item 301.2 having the first value outside a normal/tolerated range may be selected to belong to the set of clinical items for monitoring. In addition or alternatively, one or more clinical items that depend on the clinical item 301.2 e.g. clinical item BMI 301.18 may be selected (cf. FIG. 4) for monitoring. As an example, if the patient is diagnosed to have specific kidney problems, a lab test may be included into the documentation (in this case, clinical item 301.12 Serum Creatinine should be checked or tested).

Each clinical item of the set of clinical items may be associated with a final target value. The final target value may be stored in association with the clinical item in the vocabulary 300.

The selection of the set clinical items may be a pre-execution process for the present method while the remaining steps e.g. for defining the target values may be considered as post-execution processes.

In step 205, the rule engine unit 111 may determine a set of target values including intermediate target values and the final target value for each clinical item of the set of clinical items. The intermediate target values as well as the final target value of each clinical item of the set of clinical items may be predefined values stored in the storage 117 in association with different values of the clinical item. For example, the received first value of the clinical item may be A1, while in the storage system 117 multiple values A0-A9 of that clinical item are stored each in association with specific intermediate target values and a final target value. The rule engine unit 111 may read the storage system 117 and get the intermediate target values and the final target value that correspond to the value A1. In an alternative example, the rule engine unit 111 may prompt a user of CSMD 101 e.g. via the computer system 103 or the touch screen display to provide the intermediate target values and the final target value and may receive such values from the user. The set of target values may be sequenced chronologically, such that the final target value is last in the sequence.

The final target value may be for example to “Keep blood pressure below 90/140 mm Hg” or “Reduce HbA1c Level by 1%/90 days until ≦5.7 is reached”)

Besides clinical goals or target values other goals (or goal types) like education on nutrition and sport activities can be defined such that the final target value may be reached with less iterations.

In step 207, the rule engine unit 111 may generate a documentation set comprising the set of clinical items and respective set of target values associated with each clinical item of the set of clinical items. The documentation set may be for example a folder. The documentation set may be stored in the database e.g. in the vocabulary 300 of FIG. 3. In this way, the clinical and health status of the patient may be documented (e.g. is the patient already enrolled, has the patient already been seen for multiple appointments, etc.). And depending on the status and where the patient actually is within the treatment process, this documentation may vary resulting in different documentation sets e.g. a Risk Analysis, Initial Documentation and Follow-Up

Documentations. Each documentation set may be a compilation of different or partially set of clinical items.

For each clinical item of the selected set of clinical items steps 209-219 may be executed:

In step 209, a given target value may be defined as the first target value of the set of target values. For example, the first target value may be selected as the first intermediate target value in the sequence.

In step 211, the rule engine unit 111 may provide a predefined second point in time for receiving a second value of the clinical item. For example, the second point in time (t2) may be determined using the first point in time (t1), the first value (v1) of the clinical item and the final target value (vf) as follows: t2=t1+[2vf/(v1+vf) -1]*Tu, where Tu is a time unit which may comprise a day, week, month, year etc. In another example, the rule engine unit 111 may prompt the first user or another user to provide the second point in time based on the first value of the clinical item.

In step 213, the communication unit 115 may receive at the second point in time the second value for the clinical item from the first user.

In step 215, the rule engine unit 111 may compare the second value with at least the given target value. For example, the rule engine unit 111 may compare the second value with the first target value in the sequence of target values. In another example, the second value may be compared with both the first target value and another target value of the set of target values. The other target value may be the second target value in the sequence of target values and/or the final target value. This may be particularly advantageous in case the first target value is met (or reached) by the second value. In another example, in case of a second iteration the second value may be compared with the given target value of that second iteration as well as with the given target value of the previous e.g. first iteration. This may be advantageous, in particular in case in the first iteration the second value didn't meet or reach the given target value of the first iteration.

Depending on the clinical item and the given target value, the comparison may involve a different comparison operator such as Greater than (GT), Greater or equal (GE) Less than (LT), Less or equal (LE), Equal (EQ), In Between (IB) etc. For example, in case of the clinical item 301.18, BMI, the first value received at the first point in time may be BMI=33. However, the first intermediate or the final target value may be BMI=25. In this case, the comparison may involve the comparison operator LE, so that the (intermediate) goal is achieved if the BMI (received as a second value at the second point in time) drops to or below 25. In another example, in case the clinical item is the Blood pressure systolic (upper) a target value should be between 80 and 120. In this case, the comparison may involve the operator IB, i.e. a goal may be reached as long as the systolic blood pressure is in between 80 and 120.

In step 217, a score may be assigned to the first user indicative of the clinical status of the first user at the second point in time using the results of the comparison.

For example, the scores may be defined in a way, that if the second value or the first value of the clinical item met the final target value (i.e. achieved) the score may be at a maximum level. For example, 40, score points may be defined for achieving BMI value of less than 35, less than 30 and, finally, reaching of goal of getting below 25. That is, when reaching the goal the score may be at 120 score points.

In another example, the number of score points may be decreasing or increasing with the number of iterations e.g. 40, score points may be defined for achieving BMI value of less than 35, 30 score points for less than 30 and, finally, 20 score points when reaching of goal of getting below 25. This may be advantageous, as the number of iterations that were required for a patient may be used for evaluating whether the targeted clinical status is reached. For example, in case the patient reached the target values only after a sheer number of iterations, this situation may be considered as a potential fake reaching of the target which may require further checks; thus the score should go down with the number of iterations.

In a further example, the score may depend on the clinical item. For example, a higher score may be given to the clinical item blood pressure e.g. 50 score points when it reaches the final target value while a smaller score is given to the clinical item weight e.g. 10 score points when it reaches the final target value.

In step 219 if all or a predefined part of the target values have not been checked, steps 207-217 may be repeated, where for each repetition the given target value may be defined as a target value of the set of target values that has not been yet used. The predefined part of the target values may be obtained, for example, in step 217 by prompting the results of the comparison for receiving an input indicative of the part of the set of target values.

For example, if in the first iteration the first target value in the sequence has been used, in the second iteration the second target value in the sequence may be used. In another example, in case for the comparison of step 213 the second value has been compared with the first target value as well as the second target value in the sequence of target values, a third target value or the final target value may be used as the given target value in the repetition. The second point in time may be defined for each iteration as function of the previous first or second point in time. For example, in the first iteration the second point in time T2 may be defined as T2=T1+1 month as function of the first point in time T1. In the second iteration the second point in time T2′ may be defined as T2′=T2+1 week or T2′=T1+6 weeks.

The steps 207-217 may be repeated until all the target values of the set of target values or of the predefined part have been checked.

In another example, if it is found when checking the first target value of the sequence of target values that both the first and final target value are satisfied, the repetition may be stopped and not executed for example for a second target value in the sequence of target values.

Following the example described above of a clinical item being the weight of the patient. As the target values for the weight may be 90 Kg, 80 Kg and 70 Kg, the first/initial execution of steps 207-217 may check the second value of the weight obtained at the second point in time (T2) with the target value 90 Kg. If in the repetition of steps 207-217 the new check of a new second value of the weight obtained at a new second point in time (T2′, e.g. T2′=T2+1 month) reveals that the second value is indeed below 80 Kg and it is even equal to 70 Kg, the steps 207-217 may not be repeated for checking another second value that should have been obtained at another second point in time (T2″, e.g. T2″=T2′+1 week).

In step 221, it may be checked, based on the scores e.g. a combination of the scores obtained from the repetition of steps 207-217, whether a predefined disease treatment convergence criterion is met. Depending on the checking results either steps 203-219 or steps 205-219 may be repeated or the goal is reached. In other terms, either both the set of clinical items and the set of target values are to be redefined again (i.e. when repeating steps 203-219) or the set of clinical items may be kept and the set of target values may be redefined (when repeating steps 205-219).

For example, a combined score may be calculated using the scores of the set of clinical items e.g. all scores obtained for every clinical item of the set of clinical items. In another example, the combined score may be calculated using the scores of the set of clinical items that are obtained at the last iteration for each clinical item of the set of clinical items. A lower score limit and an upper score limit may be provided such that in case the combined score is below the lower score limit the steps 203-219 may be repeated. However, if the combined score is within the range defined by the lower and upper score limits steps 205-219 may be repeated. And, in case the combined score being higher than the upper score limit the disease treatment convergence criterion is met.

The combined score may be calculated by: calculating for each clinical item of the set of clinical items a relative shift value of the first value (v1) of the clinical item to the final target value (vf) of the clinical item e.g. (v1-vf)/vf; sorting by the relative shift value the set of clinical items; and assigning a weight to each clinical item of the set of clinical items in accordance with the sort. Then, calculating the combined score as a weighed sum of the scores using the assigned weights.

FIG. 3 shows a vocabulary 300 that may be used as a central dictionary containing clinical items 301.1-26 that may be relevant for the definition of goals, actions, tasks, reminders and alerts. Each clinical item 301 in the vocabulary 300 is associated with an item identifier 302, a label 303 descriptive of the clinical item 301 and/or the usage of the clinical item 301, a type name 304 specifying whether the clinical item is a vital, lab value etc., an item unit 305 defining the measurement unit of the clinical item, a data type 306 specifying the type of the variable that stores the clinical item 301. The vocabulary 300 may further comprise for each clinical item 301 a value 307 indicating whether the value of the clinical item 301 is a normal one. The vocabulary 300 may further comprise for each clinical item 301 dependencies (not shown) in the form of one or more values and/or links that refer to other clinical items in the vocabulary 300 which depend on the clinical item. Examples of labels 303 may be test HbA1 c level, get weight of the patient, get blood pressure, check if the patient has a kidney problem.

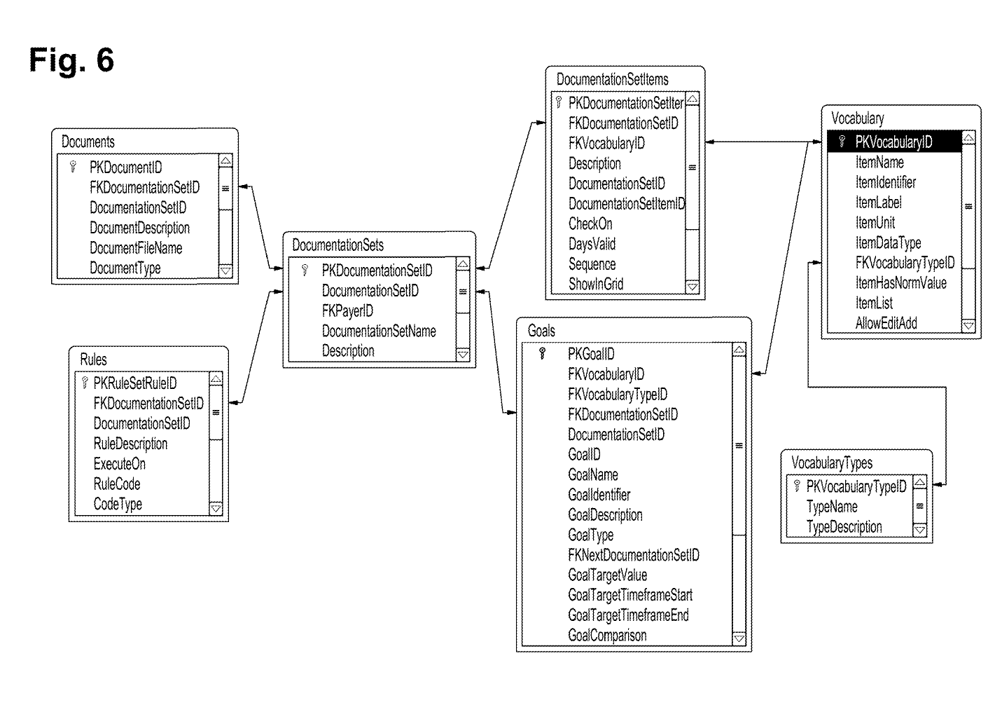

The vocabulary 300 may be configured to be modified by adding, modifying and/or removing vocabulary (clinical) items. For example, goals as well as all documentation sets and documentation set items are initially defined in the vocabulary. A related database diagram is shown in FIG. 6. FIG. 6 shows a simplified example of the relationships between the rules and the documentation sets in a database configuration.

FIG. 4 is a flowchart of a method for selecting a set of clinical items of the plurality of clinical items e.g. 301.1-301.26. Each clinical item of the plurality of the clinical items 301.1-301.26 may be associated with zero or more dependencies indicative of the dependency of the clinical item to respective zero or more clinical items of the plurality of clinical items. For example, a clinical item may depend on one or more clinical items e.g. the weight of a patient may depend on its cholesterol level. However, there may be a clinical item that does not depend on other clinical items. The selection may use as starting point an initial group of clinical items. The initial group of clinical items may be for example the at least part of the clinical items that has been defined in step 201 for the first iteration of steps 203-219. For the subsequent iterations of 203-219 e.g. the second iteration, the initial group of items may be the set of clinical items that has been selected in step 203 in the previous iteration e.g. the first iteration.

For each clinical item of the initial group of items:

In step 311, zero or more dependent clinical items may be determined from the plurality of clinical items using the dependencies of the clinical item. In other terms, it is determined whether the clinical item depends on other clinical items or not. For example, the dependencies may be represented by identifiers or links stored in the table 300 in association with the clinical item to indicate which other clinical items the clinical item depends on.

In step 313, each dependent clinical item of the zero or more dependent clinical items may be assigned an initial selection threshold value. The initial selection threshold value may be determined using the dependency value of the clinical item to the dependent clinical item. For example, in case the clinical item is the weight of the patient and the dependent clinical item is the cholesterol level of the patient, the dependency value may be encoded in the dependencies of the weight e.g. encoded in the identifier stored in table 300 in association with the weight. The dependency value may indicate, for example, an item identifier 302 of the cholesterol level. The initial threshold value e.g. 100 Kg may indicate for which weight value the cholesterol level must be controlled or not e.g. if the weight is higher than the initial threshold value the cholesterol level must be checked in a next iteration.

In step 315, the first value of the clinical item for the first iteration or the second values of the clinical item for the subsequent iteration may be compared with each of the initial threshold values. For example, the first value of the weight may be compared with the initial threshold value 100 Kg.

In step 317, selecting at least part of the zero or more dependent clinical items to be part of the set of clinical items based on the results of the comparison. For example, if the weight of the patient is higher than 100 Kg, both clinical items the weight as well as the cholesterol level may be selected in the set of clinical items.

In the following a simplified example implementation of at least part of the method described above with reference to FIGS. 2-4. In this example, the method steps such as the rules to select the set of clinical items may be defined in a script language like Javascript or C# (through a new Microsoft technology called Roslyn) and executed within an application installed in the CDMD 101 by the Microsoft script engine (the application may be written in .NET technology). From within the rules engine unit 111 the script code e.g. a .NET DLL (executing .NET managed code) may be used to perform certain functions like checking the patients prescription list for one or more specific drugs, checking existence of certain International Classification of Diseases (ICD) codes, defining goals (target values) depending on the current clinical situation and more. Because of the use of the high level utilities in the .NET DLL, the rule engine unit code can be kept simple and easy to maintain.

Example of a VB Script code for an initial documentation in the Pre-Execution process:

int ReturnValue;
if (ICD9Exists(“250.40”) ∥ ICD9Exists(“250.4”))
{

ReturnValue = AddDocumentationSetItemByID(3);

}

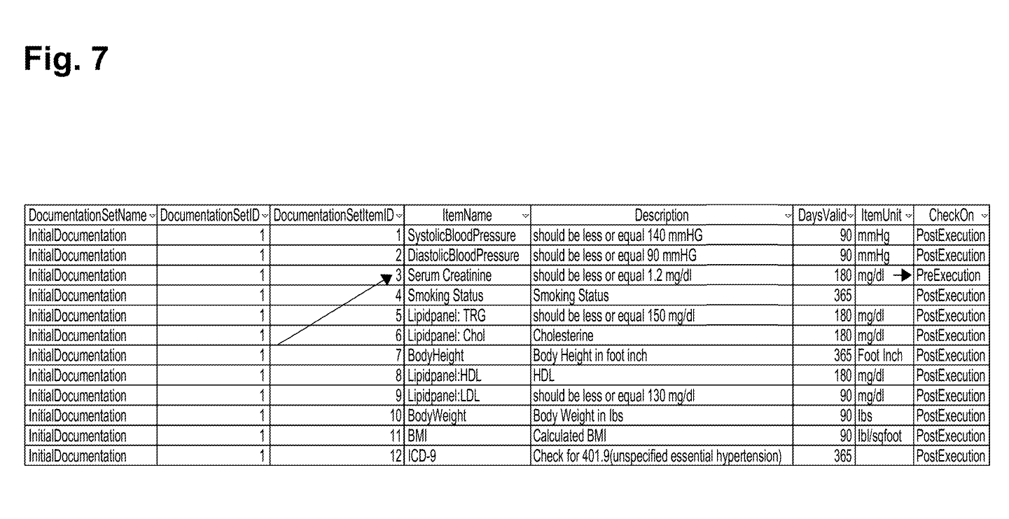

In this simple example, the .NET DLL checks if the patient has a diagnosis code of 250.4. If yes, the clinical item with the ID=3 is selected as a clinical item to be monitored (as part of the set of clinical items described above). Clinical item 3 is identified as the Serum Creatinine test. FIG. 7 shows an example for documentation set clinical items for an initial documentation i.e. the documentation set of the first or subsequent iteration that has been created and into which the clinical item with ID=3 is added:

In the Script Code, clinical item with ID 3 is referenced, defining Serum Creatinine as an optional documentation set item considered/selected with the Pre-Execution script. The DaysValid field in above table defines how recent a specific lab test or vital must be. DaysValid=90 means the most recent lab test or vital should not be older than 90 days.

Post-Execution execution Example:

bool ReturnValue = false;
bool NutritionEdu = false;
AddAllDocuments2PatientDocuments( );
AddPatientReferral(“Referral for Ophtamology Examination”,

“Ophthalmology”);

AddPatientReferral(“Referral for Dental Examination”, “Dentistry”);
AddPatientReferral(“Referral for Foot Examination”, “Podiatry”);
if (GetItemValueAsDouble(“HbA1c”, 0) >= 6.5)
{

ReturnValue = SetGoalByID(17);

}
if (GetItemValueAsDouble(“Glucose”, 0) >= 99)
{

ReturnValue = SetGoalByID(19);

}
if (GetItemValueAsDouble(“LIPIDPANEL:TRG”, 0) >= 150)
{

ReturnValue = SetGoalByID(1);

}
if (ICD9Exists(“250.40”) ∥ ICD9Exists(“250.4”))
{

if

(GetItemValueAsDouble(“KEEPSERUMCREATINIEINLINE”, 0) > 1.2)

{

ReturnValue = SetGoalByID(3);
AddPatientReferral(“Referral for Nephrology

Examination”,“Internal Medicine/Nephrology”);

}

}
if (GetItemValueAsDouble(“LIPIDPANEL:CHOL”, 0) >= 200)
{

ReturnValue = SetGoalByID(20);
AddPatientReferral(“Referral for Nutrition Education”,

“Education/Diabetes”);

NutritionEdu = true;

}
if (GetItemValueAsDouble(“LIPIDPANEL:HDL”, 0) <= 50)
{

ReturnValue = SetGoalByID(21);
if (!NutritionEdu)
{

AddPatientReferral(“Referral for Nutrition Education”,

“Education/Diabetes”);

NutritionEdu = true;

}

}
if (GetItemValueAsDouble(“LIPIDPANEL:LDL”, 0) > 100)
{

ReturnValue = SetGoalByID(2);
if (!NutritionEdu)
{

AddPatientReferral(“Referral for Nutrition

Education”,“Education/Diabetes”);

NutritionEdu = true;

}
if (GetItemValueAsDouble(“LIPIDPANEL:LDL”, 0) > 150)
{

AddRecommendation(“MEDICATION”, “Patient should

start a medication to help control their LDL”);

}

}
if (GetItemValueAsDouble(“SYSTOLICBLOODPRESSURE”,
0) > 130)
{

ReturnValue = SetGoalByID(4);

}
if (GetItemValueAsDouble(“DIASTOLICBLOODPRESSURE”,
0) > 85)
{

ReturnValue = SetGoalByID(5);

}
if (GetItemValueAsDouble(“BMI”, 0) > 25)
{

ReturnValue = SetGoalByID(10);
ReturnValue = SetGoalByID(6);
if (!NutritionEdu)
{

AddPatientReferral(“Referral for Nutrition Education”,

“Education/Diabetes”);

NutritionEdu = true;

}

}
int SmokingStatusLimit = 3;
if (GetSmokingStatusInteger( ) < SmokingStatusLimit)
{

ReturnValue = SetGoalByID(9);

}
// Set Follow Up
SetGoalByID(8);

In this example, the goal or target value with the ID 8 is set and defined without any condition as it defines the next appointment i.e. the second point in time. If the documented smoking status of the patient is coded less than 3 (means he/she is an active smoker), the goal or target values associated with ID 9 is added to the list of goals for that patients. Goal 9 defines Smoking Cessation Counseling. If the documented BMI of the patient is above 25, two more goals are set: goal 10 (Nutrition Education) and goal 6 (Increase Physical Activities).

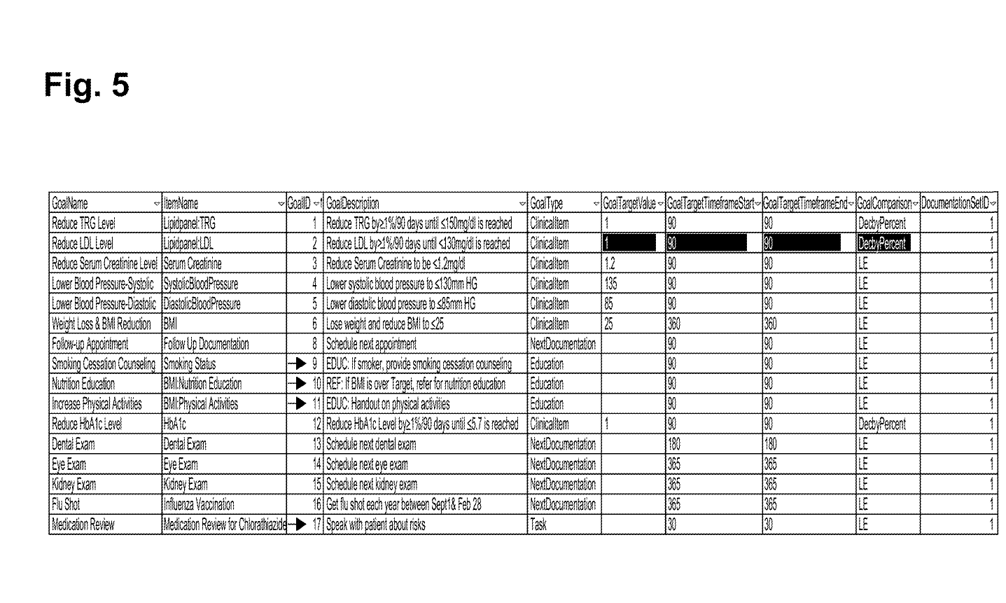

Goals or target values are also entries in the vocabulary and related to a specific documentation set. See the table of FIG. 5, showing the goals that are defined for an Initial Documentation Set in that specific example. The optional goals (e.g. goal 9) that depend on rules as described are marked with an arrow. These optional goals may be prescribed so as to help the patient to reach the defined target values of other clinical items in the set of clinical items or in the documentation set. Goals can have a patient specific target value (example: a specific BMI to achieve, here 25 as an absolute value) and a time frame in days, within the goal should be achieved (for BMI, see values surrounded by circles in FIG. 5). Target values can be specified in different units and by different comparisons. Comparisons can be less than, greater than and others. Units can be absolute or relative. As an example, the target value for goal ID 2 (Reduce LDL) is to reduce the LDL by 1% within 90 days (see values surrounded by squares in FIG. 5).

In addition to setting goals, a tracking of the compliance of goals and scoring is performed according to an underlying scoring table. Goals can be achieved in several steps (as an example, if a patient is suffering from obesity and a high BMI of 40 score points can be defined for achieving BMI value of less than 35, less than 30 and, finally, reaching of goal of getting below 25). For all defined goals, the actual goal achievement of a patient can be measured by adding all scores corresponding to the actual clinical status of the patient together and dividing this sum by the maximum total score the patient can reach:

$$Goal Achievement ( in \% ) = \frac{( Actual Sum of Scorepoints )}{( Total Sum of Scorepoints possible )} * 100$$

The goal achievement can be calculated for each individual goal or as an overall goal achievement by adding up score points for all goals defined for the patient. By this, the overall goal achievement of a specific patient can be easily tracked and monitored over time and the provider and patient can easily get an overall or individual status of his goal. Goal achievement calculation is done whenever the data of a specific patient is pulled up and, in addition, on a periodic schedule (for example every night) through a batch job processing and calculating the actual goal achievement of each single patient.

It is understood that one or more of the aforementioned embodiments may be combined as long as the combined embodiments are not mutually exclusive.

### LIST OF REFERENCE NUMERALS

101 CSMD

103 computer system

105 communication link

107 control unit

109 power supply

111 rule engine unit

113 clock

115 communication unit

117 storage system

300 vocabulary

301 clinical item

302 item identifier

303 item label

304 item type name

305 item unit

306 item data type

307 normal value check.

1. A method for monitoring a chronic disease using a chronic disease management device, the chronic disease management device comprising a rule engine unit and a receiving unit, the method comprising:
a. providing a database for storing a plurality of clinical items related to the chronic disease;
b. receiving, by the receiving unit, at a first point in time first data from a first user of the chronic disease management device, the first data being indicative of first values of at least part of the plurality of clinical items;
c. selecting by the rule engine a set of clinical items of the plurality of clinical items using at least the first values, each or some of the set of clinical items being associated with a final target value;
d. determining, by the rule engine unit, a set of target values including intermediate target values and the final target value for each or some of the set of clinical items, the set of target values being sequenced chronologically, wherein the final target value is last in the sequence;
e. generating, by the rule engine unit, a documentation set comprising the set of clinical items and respective set of target values associated with each or some of the set of clinical items;
f. storing, by the rule engine unit, the documentation set in the database;
g. for each clinical item of the set of clinical items:
I. defining a given target value as the first target value of the set of target values;
II. providing, by the rule engine unit, a predefined second point in time for receiving a second value of the clinical item;
III. receiving, by the receiving unit, at the second point in time the second value for the clinical item from the first user;
IV. comparing, by the rule engine unit, the second value with at least the given target value;
V. assigning a score to the first user indicative of the clinical status of the first user at the second point in time using the results of the comparison;
VI. repeating steps ii)-v) with the given target value being a non-used target value of the set of target values until usage of at least part of the set of target values;
h. based on the scores, repeating steps c)-g) or repeating steps d)-g) until a predefined disease treatment convergence criterion is met.

2. The method of claim 1, step h) comprising:
calculating a combined score using the scores of the set of clinical items;
providing a lower score limit and an upper score limit;
in response to determining that the combined score is below the lower score limit repeating steps c)-g);
in response to determining that the combined score is within the range defined by the lower and upper score limits repeating steps d)-g);
wherein the disease treatment convergence criterion comprises the combined score being higher than the upper score limit.

3. The method of claim 2, the at least part of the plurality of clinical items comprises the set of clinical items, wherein calculating the combined score comprises:
calculating for each or some of the set of clinical items a relative shift value of the first value of the clinical item to the final target value of the clinical item;
sorting by the relative shift value the set of clinical items;
assigning a weight to each or some of the set of clinical items in accordance with the sort;
calculating the combined score as a weighed sum of the scores using the assigned weights.

4. The method of claim 1, wherein the repetition of steps c)-g) results in two or more iterations, wherein each clinical item of the plurality of the clinical items is associated with zero or more dependencies indicative of the dependency of the clinical item to respective zero or more clinical items of the plurality of clinical items; wherein selecting the set of clinical items of the plurality of clinical items comprises:
for each clinical item of the at least part of the clinical items for the first iteration or for each clinical item of the set of clinical items for a subsequent iteration
determining zero or more dependent clinical items from the plurality of clinical items using the dependency values of the clinical item;
assigning to each dependent clinical item of the zero or more dependent clinical items an initial selection threshold value, the initial selection threshold value being determined using the de-pendency value of the clinical item to the dependent clinical item;
comparing the first value of the clinical item with each of the initial threshold values for the first iteration or comparing the second values of the clinical item with each of the initial threshold values for the subsequent iteration;
selecting at least part of the zero or more dependent clinical items to be part of the set of clinical items based on the results of the comparison.

5. The method of claim 1, wherein the repetition of steps d)-g) results in two or more iterations, wherein after each ended iteration of the two or more iterations and for each clinical item of the set of clinical items the method further comprises modifying the set of target values of the ended iteration using the score of the clinical item.

6. The method of claim 5, wherein modifying comprises one of:
shifting the set of target values of the ended iteration using the score;
adding one or more intermediate target values to the set of target values of the ended iteration, and
deleting one or more intermediate target values of the set of target values of the ended iteration.

7. The method of claim 1, wherein the repetition of steps c)-g) results in two or more iterations, wherein for each subsequent iteration after the first iteration the selection of step c) is performed using the first values and the second values of each clinical item of the set of clinical items of the previous iteration.

8. The method of claim 1, the repetition of steps ii)-v) resulting in two or more iterations, the repetition of steps ii)-v) being performed until at least one of the following conditions is fulfilled:
the score becomes higher than a predefined minimum score value associated with the clinical item,
the time elapsed between the first and the second point in time is higher than a predetermined maximum monitoring period of the clinical item, and
the second value having been checked against each target value of the set of the target values.

9. The method of claim 1, wherein the assigned score is calculated using the relative shift value of the second value to the given target value.

10. The method of claim 1, the repetition of steps ii)-v) resulting in two or more iterations each associated with a respective score, wherein the score of the clinical item is the sum of the scores of each of the two or more iterations.

11. The method of claim 1, wherein the comparison of the second value with at least the given target value comprises comparing the second value with the given target value and the final target value.

12. The method of claim 1, wherein the second point in time is received by the rule engine unit from a second user of the chronic disease management de-vice and stored in the chronic disease management device.

13. The method of claim 1, wherein the repetition in step h) results in two or more iterations, wherein the set of target values of at least the first iteration are received from a second user of the chronic disease management device.

14. A tangible computer-readable recording medium comprising computer executable instructions to perform the method steps of the method claim 1.

15. A chronic disease management device for monitoring a chronic disease, the chronic disease management device comprising a database for storing a plurality of clinical items related to the chronic disease, the chronic disease management device further comprising:
a receiving unit for receiving, at a first point in time first data from a first user of the chronic disease management device, the first data being indicative of first values of at least part of the plurality of clinical items;
a rule engine unit for:
1)selecting a set of clinical items of the plurality of clinical items using at least the first values, each or some of the set of clinical items being associated with a final target value;
2)determining a set of target values including intermediate target values and the final target value for each or some of the set of clinical items, the set of target values being sequenced chronologically, wherein the final target value is last in the sequence;
3)generating a documentation set comprising the set of clinical items and respective set of target values associated with each clinical item of the set of clinical items;
4)storing the documentation set in the database;
5)for each clinical item of the set of clinical items:
i. defining a given target value as the first target value of the set of target values;
ii. providing a predefined second point in time for receiving a second value of the clinical item;
iii. receiving, via the receiving unit, at the second point in time the second value for the clinical item from the first user;
iv. comparing the second value with at least the given tar-get value;
v. assigning a score to the first user indicative of the clinical status of the first user at the second point in time using the results of the comparison;
vi. repeating steps ii)-v) with the given target value being a non-used target value of the set of target values until us-age of at least part of the set of target values;
6)based on the scores, repeating steps 1)-5) or repeating steps 2)-5) until a predefined disease treatment convergence criterion is met.
